(19) United States
(12) Patent Application Publication
(10) Pub. No.: US 2026/0281712 A1
(43) Pub. Date: Sep. 17, 2026

(54) SYSTEM AND METHOD FOR ANONYMOUS, LICENSE-PLATE BASED VEHICLE-TO-EVERYTHING (V2X) COMMUNICATION

(71) Applicant: Edward A. Zumbiel, Union (KY)

(72) Inventor: Edward A. Zumbiel, Union (KY)

(21) Appl. No.: 19/563,268

(22) Filed: Mar. 11, 2026

Related U.S. Application Data
(60) Provisional application No. 63/770,415, filed on Mar. 12, 2025.

(51) Int. Cl. H04W 12/033; H04W 12/63

(52) U.S. Cl. CPC H04W 12/033; H04W 12/63

(57) ABSTRACT

A method includes receiving, from a user device, data representing a geographic position of a first vehicle. The method further includes identifying one or more proximate vehicles located within a predetermined proximity of the first vehicle. The method further includes obtaining an anonymized identifier (AID) for each proximate vehicle determined to be contactable. The method further includes transmitting, to the user device, map overlay data including the AID and location data for each contactable proximate vehicle to cause the first vehicle to display the map overlay data. The method further includes receiving, from the user device, a request to establish a communication session with a second vehicle. The method further includes using a routing token to deliver the request to another user device within the second vehicle. The method further includes establishing the communication session between the user device and the other user device to permit anonymous communication.

### RELATED APPLICATION

The present application claims priority to U.S. Provisional Ser. No. 63/770,415, filed Mar. 12, 2025, the disclosure of which is hereby incorporated by reference in its entirety.

### TECHNICAL FIELD

This invention relates to systems and methods providing anonymous, real-time communication between vehicles through an application utilizing license plate-based identification and opt-in user location visibility.

### BACKGROUND

Traditional vehicle-to-vehicle communication is limited to rudimentary gestures, honking, and/or third-party messaging applications. In many driving scenarios, a driver may wish to communicate with nearby drivers regarding roadway conditions, safety concerns, or cooperative driving maneuvers. For example, a driver may wish to notify another driver of a mechanical issue, request permission to merge or pass, warn another driver of a hazard on or near the road, or coordinate navigation in congested traffic. Conventional signaling methods, such as honking or hand gestures, are often ambiguous and limited in the amount of information they can convey. Such signals may also be misinterpreted or perceived as aggressive, leading to confusion or unsafe driving situations.

Existing mobile communication technologies also fail to adequately address driver-to-driver communication needs. Conventional messaging or voice communication applications typically require prior knowledge of another user's contact information, such as a phone number, username, or account identifier. As a result, these systems are not well suited for spontaneous communication between drivers who encounter one another temporarily on the roadway. In addition, the disclosure of contact information between unknown drivers raises both privacy and security concerns.

Some vehicle communication technologies may attempt to provide location-based awareness of nearby vehicles, but such systems often rely on specialized hardware, proprietary communication standards, or infrastructure-based vehicle telemetry. These systems may not provide a convenient mechanism for initiating voluntary communication between drivers, particularly where user consent, anonymity, and privacy are desired. Further, existing approaches may expose identifying information of a vehicle or driver which discourages use by drivers who wish to maintain anonymity.

Another challenge involves presenting nearby vehicle information in a manner that is intuitive and safe for drivers to interact with while operating a vehicle. Systems that require manual entry of identifiers, scanning of license plates, or searching through lists of nearby users can distract drivers and reduce usability. Additionally, conventional mobile device applications may not integrate effectively with vehicle infotainment systems or driver interfaces.

Accordingly, there exists a need for improved systems and methods that enable drivers to discover nearby vehicles in a location-aware manner, selectively initiate communication with other drivers, and exchange information in real time while preserving anonymity and protecting personally identifiable information. There is also a need for such systems to operate using widely available computing devices and vehicle infotainment interfaces while minimizing driver distraction.

### SUMMARY

In an aspect of the invention, a method for anonymous, vehicle-to-everything (V2X) communication is disclosed. The method includes receiving, by a server and from a device within a first vehicle, location data representing a geographic position of the first vehicle. The device is associated with a first user account of a user registered with a V2X communication application. The method further includes identifying, by the server and based on the location data, one or more proximate vehicles located within a predetermined proximity of the geographic position of the first vehicle. The method further includes determining, by the server and for each user account corresponding to a respective proximate vehicle of the one or more proximate vehicles, whether the user account is contactable based on one or more contact conditions. The method further includes obtaining, by the server, an anonymized identifier (AID) for each proximate vehicle associated with a corresponding user account determined to be contactable. The method further includes transmitting, by the server and to the device within the first vehicle, map overlay data including the AID and respective location data for each proximate vehicle associated with the corresponding user account determined to be contactable. Transmitting the map overlay data to the device within the first vehicle causes a map interface in the first vehicle to display the map overlay data. The method further includes receiving, by the server and from the device within the first vehicle, a request to establish a communication session with a selected second vehicle corresponding to a second user account determined to be contactable. The request includes the AID of the selected second vehicle. In response to receiving the request, the method further includes using, by the server, the AID to obtain a routing token and using the routing token to deliver the request to a device within the selected second vehicle without providing personally identifiable information associated with the second user account to the device in the first vehicle. The method further includes establishing, by the server, the communication session between the device within the first vehicle and the device within the selected second vehicle to permit anonymous communication.

In an embodiment of the invention, the map overlay data excludes personally identifiable information associated with each proximate vehicle.

In another embodiment of the invention, each of the one or more contact conditions represents a condition under which a particular user account is determined to be not contactable. The one or more contact conditions include at least one of a do-not-disturb mode enabled for the particular user account, the particular user account blocking the first user account, the particular user account not being opted in to location-based visibility within the V2X communication application, a communication schedule restriction configured for the particular user account, or a rate limit associated with the particular user account that restricts receipt of additional communication requests.

In another embodiment of the invention, the map interface displays the AID for each proximate vehicle associated with the corresponding user account determined to be contactable and a vehicle indicator for each of the one or more proximate vehicles including at least one non-contactable proximate vehicle.

In another embodiment of the invention, the device within the first vehicle is a mobile device executing the V2X communication application and is communicatively coupled to a vehicle infotainment system of the first vehicle via a display integration interface. In this embodiment, the map overlay data is rendered as an overlay on the map interface which is presented on a display of the vehicle infotainment system.

In another embodiment of the invention, the request to establish the communication session is initiated via a voice command received through the vehicle infotainment system.

In another embodiment of the invention, the request to establish the communication session includes the AID as an addressing input used by the server to obtain the routing token for delivering the request without exposing the personally identifiable information associated with the second user account.

In another embodiment of the invention, establishing the communication session includes relaying, by the server, an audio communication session between the device within the first vehicle and the device within the selected second vehicle using a server-mediated voice-over-Internet-Protocol (VoIP) relay system such that network endpoint information associated with each device is not directly exposed between the device within the first vehicle and the device within the selected second vehicle.

In an aspect of the invention, a device is provided. The device includes one or more memories and one or more processors, communicatively coupled to the one or more memories. The one or more processors are to receive, from a device within a first vehicle, location data representing a geographic position of the first vehicle. The device within the first vehicle is associated with a first user account of a user registered with a vehicle-to-everything (V2X) communication application. The one or more processors are further to identify, based on the location data, one or more proximate vehicles located within a predetermined proximity of the geographic position of the first vehicle. The one or more processors are further to determine, for each user account corresponding to a respective proximate vehicle of the one or more proximate vehicles, whether the user account is contactable based on one or more contact conditions. The one or more processors are further to generate an anonymized identifier (AID) for each proximate vehicle associated with a corresponding user account determined to be contactable. The one or more processors are further to transmit, to the device within the first vehicle, map overlay data including the AID and respective location data for each proximate vehicle associated with the corresponding user account determined to be contactable. Transmitting the map overlay data to the device within the first vehicle causes a map interface in the first vehicle to display the map overlay data. The one or more processors are further to receive, from the device within the first vehicle, a request to establish a communication session with a selected second vehicle corresponding to a second user account determined to be contactable. The request includes the AID of the selected second vehicle. In response to receiving the request, the one or more processors are further to use the AID to obtain a routing token and using the routing token to deliver the request to a device within the selected second vehicle without providing personally identifiable information associated with the second user account to the device in the first vehicle. The one or more processors are further to establish the communication session between the device within the first vehicle and the device within the selected second vehicle to permit anonymous communication.

In an embodiment of the invention, the one or more processors, when generating the AID, are to generate the AID as a time-limited identifier that expires after a timer interval. In this embodiment, the one or more processors are further to generate a new AID for the corresponding proximate vehicle upon expiration of the timer interval.

In another embodiment of the invention, the map overlay data excludes a vehicle registration identifier for each of the one or more proximate vehicles.

In another embodiment of the invention, the one or more processors are further to generate the map overlay data to include the AID for each proximate vehicle associated with the corresponding user account determined to be contactable and to further include a vehicle indicator for each of the one or more proximate vehicles including at least one non-contactable proximate vehicle.

In another embodiment of the invention, the device within the first vehicle is a user device executing the V2X communication application and is communicatively coupled to a vehicle infotainment system of the first vehicle via a display integration interface. In this embodiment, the map overlay data is rendered as an overlay on the map interface which is presented on a display of the vehicle infotainment system.

In another embodiment of the invention, the request to establish the communication session is initiated via a voice command received through the vehicle infotainment system.

In another embodiment of the invention, the request to establish the communication session includes the AID as an addressing input used by the one or more processors to obtain the routing token for delivering the request without exposing the personally identifiable information associated with the second user account.

In another embodiment of the invention, the one or more processors, when establishing the communication session, are to relay an audio communication session between the device within the first vehicle and the device within the selected second vehicle using a server-mediated relay system such that network endpoint information associated with each device is not directly exposed between the device within the first vehicle and the device within the selected second vehicle.

In an aspect of the invention, a non-transitory, computer-readable medium is provided. The non-transitory, computer-readable medium stores one or more instructions that, when executed by one or more processors, cause the one or more processors to receive, from a device within a first vehicle, location data representing a geographic position of the first vehicle. The device is associated with a first user account of a user registered with a vehicle-to-everything (V2X) communication application. The one or more instructions further cause the one or more processors to identify, based on the location data, one or more proximate vehicles located within a predetermined proximity of the geographic position of the first vehicle. The one or more instructions further cause the one or more processors to determine, for each user account corresponding to a respective proximate vehicle of the one or more proximate vehicles, whether the user account is contactable based on one or more contact conditions. The one or more instructions further causes the one or more processors to generate an anonymized identifier (AID) for each proximate vehicle associated with a corresponding user account determined to be contactable. The one or more instructions further cause the one or more processors to transmit, to the device within the first vehicle, map overlay data including the AID and respective location data for each proximate vehicle associated with the corresponding user account determined to be contactable. Transmitting the map overlay data to the device within the first vehicle causes a map interface in the first vehicle to display the map overlay data. The one or more instructions further cause the one or more processors to receive, from the device within the first vehicle, a request to establish a communication session with a selected second vehicle corresponding to a second user account determined to be contactable. The request includes the AID of the selected second vehicle. In response to receiving the request, the one or more instructions further cause the one or more processors to use the AID to obtain a routing token and using the routing token to deliver the request to a device within the selected second vehicle without providing personally identifiable information associated with the second user account to the device in the first vehicle. The one or more instructions further cause the one or more processors to establish the communication session between the device within the first vehicle and the device within the selected second vehicle to permit anonymous communication.

In an embodiment of the invention, the map overlay data excludes personally identifiable information associated with each proximate vehicle.

In another embodiment of the invention, the map interface displays the AID for each proximate vehicle associated with the corresponding user account determined to be contactable and a vehicle indicator for each of the one or more proximate vehicles including at least one non-contactable proximate vehicle.

In another embodiment of the invention, the request to establish the communication session includes the AID as an addressing input used by the server to obtain the routing token for delivering the request without exposing the personally identifiable information associated with the second user account.

### BRIEF DESCRIPTION OF THE DRAWINGS

The above-mentioned and other features and advantages of this invention, and the manner of attaining them, will become more apparent and the invention itself will be better understood by reference to the following description of embodiments of the invention taken in conjunction with the accompanying drawings.

FIG. 1A is a diagram illustrating a user registering for a vehicle-to-everything (V2X) communication application.

FIG. 1B is a diagram illustrating a user device connecting with a vehicle infotainment system.

FIG. 1C is a diagram illustrating a communication management platform identifying one or more proximate vehicles located in a predetermined proximity of a vehicle of the user.

FIG. 1D is a diagram illustrating the communication management platform obtaining an anonymized identifier (AID) for each user account that corresponds to a proximate vehicle that is determined to be contactable.

FIG. 1E is a diagram illustrating map overlay data being rendered as an overlay on a map interface.

FIG. 1F is a diagram illustrating the user requesting to establish a communication session with a second user, where the second user accepts the request.

FIG. 1G is a diagram illustrating the communication management platform establishing a communication session between the user device of the user and a user device of the second user.

FIG. 2 is a diagram of an example environment in which systems and/or methods described herein may be implemented.

FIG. 3 is a diagram of example components of one or more devices of FIG. 2.

### DETAILED DESCRIPTION

The following detailed description of example embodiments refers to the accompanying drawings. The same reference numbers in different drawings may identify the same or similar elements.

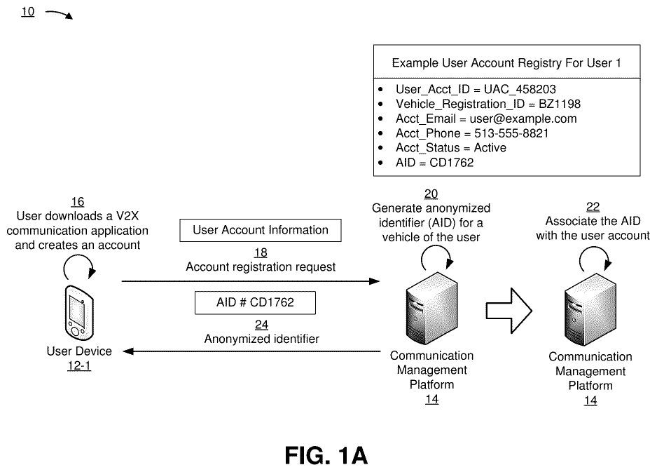

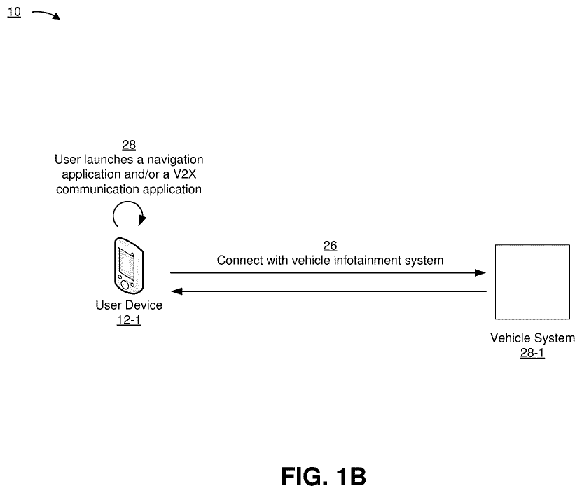

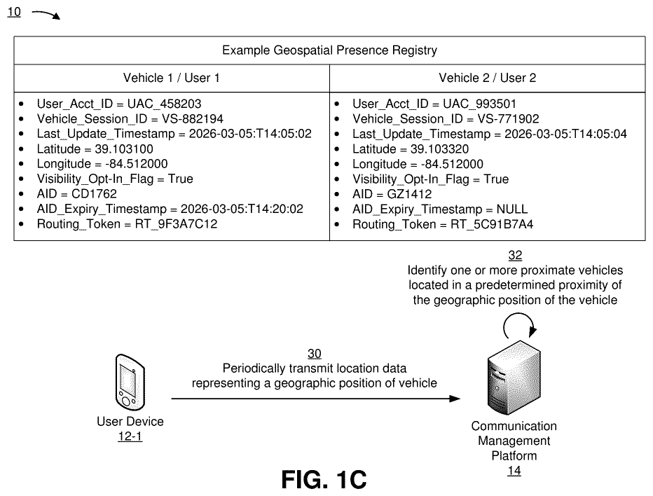

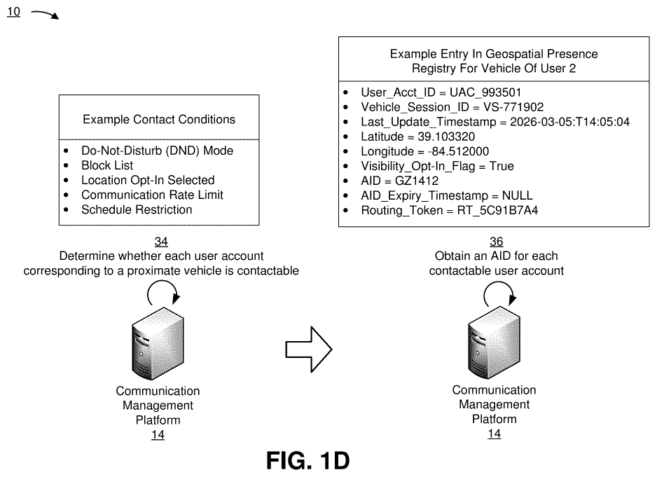

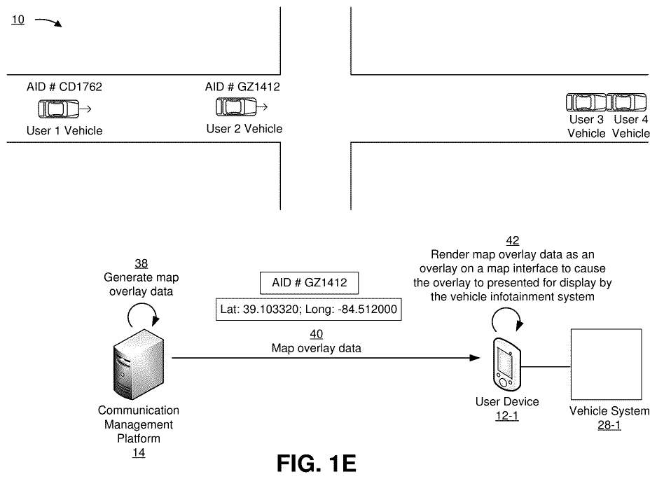

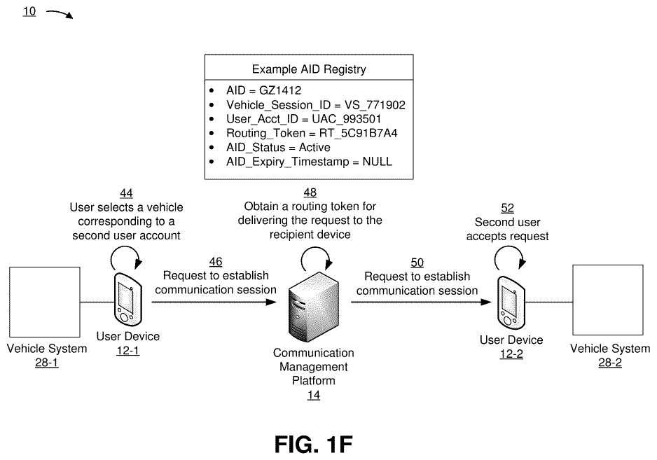

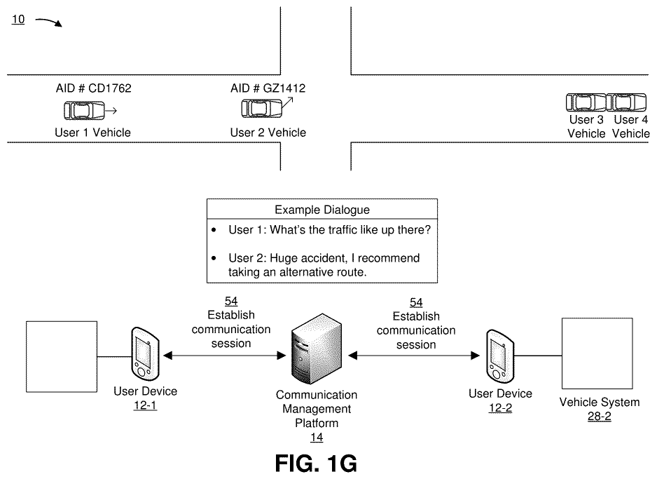

FIGS. 1A-1G are diagrams of an example process 10 for providing anonymous, vehicle-to-everything (V2X) communication according to the principles of the present disclosure. V2X communication may include Vehicle-to-vehicle (V2V) communication, vehicle-to-Infrastructure (V2I) communication, vehicle-to-network (V2N) communication, vehicle-to-pedestrian (V2P) communication, and/or vehicle-to-device (V2D) communication. Further, while some embodiments described herein refer to communication between two vehicles, it is to be understood that this is provided by way of example. In practice, any number of vehicles and/or other devices may communicate as part of the same communication session (e.g., a three-way call, a four-way call, etc.).

In example embodiments described herein, V2X communication operates through a sequence of stages that enable nearby vehicle operators to establish anonymous communication sessions. These stages include (1) initializing a user account and assigning an anonymized identifier (AID) associated with a vehicle (see, e.g., FIG. 1A), (2) connecting a user device with a vehicle system and transmitting vehicle location data to a communication management platform to maintain a geospatial presence registry of participating vehicles (see, e.g., FIGS. 1B and 1C), (3) identifying proximate vehicles and generating map overlay data that includes AIDs and location data for nearby vehicles (see, e.g., FIGS. 1C-1E), and (4) establishing an anonymous communication session between vehicles through the communication management platform (see, e.g., FIGS. 1F and 1G). The figures described below illustrate example embodiments of these stages and corresponding interactions between user devices, vehicle systems, and the communication management platform.

FIG. 1A is a diagram showing a user device 12-1 and a communication management platform 14. Specifically, FIG. 1A shows a user registering for a V2X communication application that provides V2X communication between vehicles. As shown by reference number 16, the user may download the V2X communication application and may create an account. The V2X communication application may be a mobile application, a web application, a desktop application, and/or the like. During the account setup process, the user may interact with a user interface of the V2X communication application to provide user account information, such as user identity information, vehicle information, device information, one or more user preferences and/or privacy settings, location sharing consent and application permission settings, and/or the like.

The user identity information may include a name, an email address, a phone number, an account password, and/or the like. The vehicle information may include a vehicle registration identifier for a vehicle, such as a license plate number, a make of the vehicle, a model of the vehicle, a year of the vehicle, a color of the vehicle, and/or the like. The device information may include a device identifier (e.g., a V2X communication application-generated identifier, such as DEV-88201), an international mobile equipment identifier (IMEI), etc.), a device type (e.g., iPhone, Android, etc.), an operating system, and/or the like. The user preferences and privacy settings may include a visibility preference (e.g., “allow my vehicle to appear to nearby drivers”), a communication request preference (e.g., “allow nearby drivers to send communication requests”), a do-not-disturb (DND) mode preference (e.g., “disable communication requests while driving”), a blocked user list, a preferred mode of communication (e.g., voice, text, voice and text, etc.), and/or the like. The location sharing consent and application permission settings may include a location sharing permission setting (e.g., “allow application to access device location”), a location sharing preference setting (e.g., “share my vehicle with nearby drivers”), a location update frequency setting (e.g., “update location in real-time, every five seconds, every ten seconds, etc.”), and/or the like.

As shown by reference number 18, when the user creates the account, the user device 12-1 may provide an account registration request to the communication management platform 14. The account registration request may include the user identity information, the vehicle information, the device information, the one or more user preferences and/or privacy settings, and/or the location sharing consent and application permission settings.

In some embodiments, the communication management platform 14 may generate an account for the user based on the information included in the account registration request. For example, the communication management platform 14 may generate an account that includes an account identifier for the user account and may store the account identifier in association with other user account information provided in the account registration request.

As shown by reference number 20, the communication management platform 14 may generate an AID for a vehicle of the user. An AID refers to an identifier associated with a vehicle or vehicle session that allows a user to reference and communicate with nearby vehicles without exposing personally identifiable information associated with the user's account. In some embodiments, an AID may resemble a vehicle license plate format (e.g., alphanumeric characters) but while being different than an actual license plate number of a user's vehicle. In other embodiments, an AID may include a numeric identifier, shortened identifier, descriptive identifier, or other identifier usable for identifying a vehicle in a map interface or communication request. By using the AID, rather than a license plate number, the communication management platform 14 improves privacy and safety by not publishing personally identifiable information of the user.

In some embodiments, the communication management platform 14 may use the license plate of the user (e.g., instead of an AID). For example, in certain deployments, such as fleet deployments, closed user groups, or jurisdictions where vehicle identity disclosure is permissible, the communication management platform 14 may be configured to use an actual license plate number as an identifier displayed in the map interface and/or used for initiating communication requests. In these deployments, the communication management platform 14 may still preserve contact privacy by routing communications through the communication management platform 14 such that phone numbers and other direct contact information are not exchanged between participants.

As shown by reference number 22, the communication management platform 14 may associate the AID with the user account. For example, the communication management platform 14 may store the AID using a data structure to associate the AID with user account information such as a user account identifier, a vehicle registration identifier (e.g., a license plate number), an email address, a phone number, an account status (e.g., active, paused, disabled, etc.), and/or the like. In the example shown, the user (shown as User 1) has an account identifier of “UAC_458203”, a vehicle registration identifier of “BZ1198”, an email address of “user@example.com”, a phone number of “513-555-821”, an account status of “active”, and an AID of CD1762. In some embodiments, the AID may also be stored in association with other user-provided information, such as the device information, the one or more user preferences and/or privacy settings, the location sharing consent and application permission settings, and/or the like.

As shown by reference number 24, the communication management platform 14 may provide the AID to the user device 12-1. For example, the communication management platform 14 may provide the AID to the user device 12-1 so that the AID can be stored locally for future use. In some embodiments, the AID may expire after a threshold time period.

As shown in FIG. 1B, and by reference number 26, the user device 12-1 may connect with an infotainment system of the vehicle of the user. The infotainment system may be part of a vehicle system 28-1 which also includes a vehicle navigation system, a vehicle communication system, and/or the like.

In some embodiments, the user device 12-1 may connect with the vehicle system 28-1 through a display integration interface that allows applications executing on the user device 12-1 to be presented through the infotainment system. The display integration interface may include a mobile device integration framework such as Apple CarPlay®, Android Auto®, a Bluetooth®-based projection interface, a wireless projection interface, a wired projection interface (e.g., via a universal serial bus (USB)), and/or a native vehicle infotainment application environment implemented within a vehicle operating system that enables map overlays, notifications, voice commands, and user interface elements to be presented as part of a vehicle infotainment display. Using the display integration interface, the infotainment system may present content generated by the user device 12-1 on a display of the vehicle while allowing the user to interact with the V2X management application (and/or a corresponding navigation application) using the vehicle infotainment display, voice input, steering wheel controls, and/or other vehicle input mechanisms.

As shown by reference number 28, the user may interact with the user device 12-1 to launch a navigation application and/or the V2X communication application. In some embodiments, the V2X communication application may operate as a standalone application that provides location-based communication functionality while integrating with a separate navigation application to obtain map data and/or vehicle location information. For example, the user may launch a navigation application (e.g., Apple Maps®, Google Maps®, Waze®, etc.) while the V2X communication application executes in the background and exchanges location information with the communication management platform 14 to identify nearby vehicles. In other embodiments, the V2X communication application may include integrated navigation functionality that allows the application to provide both navigation services and location-based V2X communication services within a single application interface. In either case, when the application is launched, the user device 12-1 may begin providing the communication management platform 14 with location data to be used to support location-based V2X communication with nearby vehicles, as described further below. In some embodiments, the user device 12-1 may periodically transmit other types of data with the location data, including a user account identifier, a vehicle session identifier, a vehicle speed, a timestamp, and/or the like.

As shown in FIG. 1C, and by reference number 30, the user device 12-1 may periodically transmit, to the communication management platform 14, location data representing a geographic position of the vehicle. For example, while the user is driving the vehicle along a route, the user device 12-1 may periodically transmit, to the communication management platform 14, location data such as geographic coordinates data (e.g., latitude and longitude), altitude data, direction of travel data, timestamp data, and/or related data such as data indicating a vehicle speed. The location data may be obtained using one or more positioning components of the user device 12-1, such as a global positioning system (GPS) receiver, wireless fidelity (Wi-Fi) positioning, cellular triangulation, inertial sensors, and/or the like.

In some embodiments, transmission of the location data may be triggered based on one or more conditions, such as launching the V2X communication application, launching a navigation application, connection of the user device 12-1 with the vehicle system 28-1 via the display integration interface, detection that the vehicle is moving above a threshold speed, expiration of a periodic reporting interval, detection of a change in geographic position exceeding a threshold distance, and/or the like. In some embodiments, the location data may be transmitted at a configurable reporting interval, such as every one second, every five seconds, every ten seconds, or another interval specified by a location update preference setting of the user. In some embodiments, the reporting interval may dynamically adjust based on factors such as vehicle speed, proximity to other vehicles, network availability, battery level of the user device 12-1, and/or the like.

Further, some embodiments described herein refer to establishing a vehicle session. A vehicle session may refer to a logical session representing active participation of a vehicle system (e.g., vehicle system 28-1) and/or a user device (e.g., user device 12-1) with the V2X communication application. A vehicle session may be initiated when a user launches the V2X communication application, connects a user device (e.g., user device 12-1) to a vehicle infotainment system (e.g., an infotainment system of vehicle system 28-1), or begins transmitting location data to the communication management platform 14. A vehicle session may be associated with a vehicle session identifier, a routing token, an AID, and/or location data for the vehicle. In some embodiments, the vehicle session may terminate when the application is closed, when location reporting stops, when the user device (e.g., user device 12-1) disconnects from the vehicle, or after expiration of a timeout period.

As shown by reference number 32, the communication management platform 14 may identify one or more proximate vehicles located in a predetermined proximity of the geographic position of the vehicle. As used herein, the term “proximate vehicle” refers to a vehicle located within a defined geographic proximity relative to another vehicle. The proximity may be defined using a configurable distance threshold, geographic radius, roadway segment, or other spatial relationship. In some embodiments, to identify the one or more proximate vehicles, the communication management platform 14 may query a data structure such as a geospatial presence registry maintained by the communication management platform 14. The geospatial presence registry may store, for multiple active vehicles, entries containing location data (e.g., geographic coordinates, 3-D coordinates, etc.) and session information associated with user accounts currently participating in V2X communication. For example, each registry entry may include a user account identifier, a vehicle session identifier, a last update timestamp representing when location data was most recently received, geographic coordinates representing the vehicle location, a visibility preference indicating whether the vehicle is permitted to appear to nearby drivers, an AID associated with the vehicle, an AID expiration timestamp, and/or a routing token used to deliver communication requests to a device of another user registered with the V2X communication application. In this case, the communication management platform 14 may use the location data for the vehicle of the user to identify nearby vehicles of other registered users.

In some embodiments, the communication management platform 14 may perform a geospatial query that identifies vehicles whose stored geographic coordinates fall within a defined radius of the geographic position received from the user device 12-1. For example, the predetermined proximity may correspond to a radius of approximately 50 meters, 100 meters, 250 meters, or another configurable distance. In the example shown in FIG. 1C, the geospatial presence registry may include an entry for the vehicle of the user (shown as User 1) and an entry for a vehicle of a second user (shown as User 2) whom the communication management platform 14 has identified as being located within the predetermined proximity of the vehicle of the user.

As shown in FIG. 1D, and by reference number 34, the communication management platform 14 may determine whether each user account corresponding to a proximate vehicle is contactable. In some embodiments, the communication management platform 14 may determine whether the user account corresponding to the proximate vehicle is contactable based on one or more contact conditions associated with the user account. The one or more contact conditions may include a do-not-disturb (DND) mode status, a block list, a location opt-in preference, a communication rate limit, a schedule restriction, and/or other user-defined communication preferences.

The DND mode status may indicate whether the user has enabled a setting that temporarily disables incoming communication requests from nearby vehicles. The block list may include identifiers associated with other users or vehicles from which communication requests should not be received. The location opt-in preference may indicate whether the user has enabled a setting that allows the vehicle to appear to nearby drivers within the V2X communication system. The communication rate limit may specify a maximum number of communication requests that may be received within a defined time window to prevent excessive or abusive communication attempts. The schedule restriction may define one or more time periods during which communication requests are permitted or restricted. Based on evaluating one or more of these contact conditions, the communication management platform 14 may determine whether the corresponding user account is eligible to receive a communication request from another nearby vehicle.

In some embodiments, to determine whether each user account is contactable, the communication management platform 14 may reference one or more data structures, such as the geospatial presence registry, a user account registry, a user preference data store, and/or a communication policy or rate-limiting data store. For example, the communication management platform 14 may reference the geospatial presence registry to confirm that a visibility preference associated with the vehicle session permits a vehicle to appear to nearby users. The communication management platform 14 may also retrieve user preference data associated with corresponding the user account to determine whether one or more additional contact conditions are satisfied, such as whether a do-not-disturb setting is enabled, whether the requesting user is included in a blocked users list (or vice versa), whether communication rate limits have been exceeded, and/or whether time-based communication restrictions are active. Based on evaluating these conditions, the communication management platform 14 may determine whether a proximate vehicle is eligible to receive a communication request.

As shown by reference number 36, the communication management platform 14 may obtain an AID for each contactable user account. For example, the communication management platform 14 may obtain the AID by referencing the geospatial presence registry which associates the user account information for each contactable user account with a corresponding AID.

In the example shown in FIG. 1D, the communication management platform 14 obtains an AID for a second user (shown as User 2). In this example, the geospatial presence registry may include an entry corresponding to the vehicle of the second user. That entry includes a user account identifier value of “UAC_993501”, a vehicle session identifier value of “VS-771902”, last updated timestamp value of “2026-03-05:T14:05:04”, a latitude value of “39.103320”, a longitude value of “−84.512000”, a visibility opt-in flag value of “True”, an AID value of “GZ1412”, an AID expiration timestamp value of “NULL”, and a routing token value of “RT_5C91B7A4”. Based on determining that the user account associated with this entry is contactable, the communication management platform 14 may obtain the AID “GZ1412” for use in subsequent communication operations.

In some embodiments, the communication management platform 14 may generate the AID dynamically for the contactable user account. For example, the communication management platform 14 may generate a temporary AID associated with the vehicle session of the user and may store the AID in association with the vehicle session identifier and a routing token used to deliver communication requests to the corresponding user device. In this case, the AID may expire after a defined time period or after termination of the vehicle session. For example, an AID expiration timestamp may be stored to indicate when the AID should be invalidated or replaced with a new AID.

As shown in FIG. 1E, and by reference number 38, the communication management platform 14 may generate the map overlay data. For example, the communication management platform 14 may generate the map overlay data in real-time or near real-time based on location data received from multiple user devices associated with vehicles participating in the V2X communication system. In this case, the communication management platform 14 may process entries stored in the geospatial presence registry to identify nearby vehicles and may generate map overlay data representing the relative positions of those vehicles and corresponding AIDs.

The map overlay data may include, for example, location data representing the geographic coordinates of one or more nearby vehicles, an AID associated for each proximate vehicle that has been determined to be contactable, a vehicle indicator, a proximity indicator, a contactability indicator, and/or other information that may be rendered as an overlay on a navigation or map interface. In some embodiments, a proximity indicator may represent information indicating a relative distance, direction, or spatial relationship between the vehicle of the user and one or more nearby vehicles (e.g., vehicles within a defined radius, vehicles ahead on a roadway segment, or vehicles within a particular lane or direction of travel). In some embodiments, a contactability indicator may represent information indicating whether a corresponding vehicle is available to receive communication requests, such as whether the vehicle is associated with a registered user account, whether the user has opted in to location visibility, whether a do-not-disturb setting is enabled, and/or whether other communication conditions permit receipt of a communication request.

As shown by reference number 40, the communication management platform 14 may provide map overlay data to the user device 12-1. For example, the communication management platform 14 may transmit the map overlay data to the user device 12-1 for rendering within a map interface. In some embodiments, the communication management platform 14 may periodically generate and transmit updated map overlay data based on updated location data received from proximate vehicles. For example, similar to the periodic transmission of location data described above, the communication management platform 14 may update the map overlay data at a defined reporting interval (e.g., every one second, every five seconds, or another configurable interval) so that the positions and identifiers of nearby vehicles are refreshed while the vehicle of the user is traveling along a route.

In the example shown, the map overlay data provided may include an AID associated with the vehicle system 28-2 (e.g., GZ1412) and location data of the vehicle of the second user (shown as User 2) who is determined to be driving within the predetermined geographic location of the user (e.g., Lat: 39.103320; Long: −84.51200). In some embodiments, the map overload data may further include a vehicle indicator type value (e.g., “vehicle_icon”), a heading value (e.g., 12 degrees), and/or a contactability indicator value (e.g., “True”). Additionally, or alternatively, the map overlay data may further include data corresponding to one or more noncontactable vehicles. For example, the map overlay data for User Vehicle 3 may include a vehicle indicator type value (“vehicle_icon”), location data values (e.g., “Lat: 39.103480; Long: −84.51200”), a heading value (e.g., 10 degrees), a contactability indicator value (e.g., “False”), and an AID value (e.g., NULL).

As shown by reference number 42, the user device 12-1 may render the map overlay data as an overlay on a map interface which may then be presented for display by the vehicle infotainment system of the vehicle system 28-1. In some embodiments, as updated map overlay data is periodically received from the communication management platform 14, the user device 12-1 may update the rendered overlay to reflect changing vehicle positions, proximity relationships, and contactability status of proximate vehicles while the vehicle of the user continues to travel.

The map interface may be displayed via an on-vehicle infotainment system, a projection framework that mirrors a user device user interface onto the vehicle display, and/or a native vehicle head unit application. Non-limiting examples of projection frameworks include Apple CarPlay® and Android Auto®, although other OEM-specific projection or head unit frameworks may be used.

In some embodiments, the map interface may display vehicle indicators for multiple nearby vehicles while displaying AIDs only for vehicles associated with registered users that have opted in to location visibility and communication functionality. For example, vehicles associated with registered and opted-in users may appear with a corresponding AID (e.g., “CD1762” or “GZ1412”), while other vehicles may appear only as generic vehicle indicators without an AID. A vehicle indicator refers to a graphical representation of a vehicle displayed on a map interface. For example, a vehicle indicator may include an icon, symbol, or graphical marker indicating the position of a nearby vehicle.

In some embodiments, vehicles that are not registered with the V2X communication system or that have not opted in to location visibility may be omitted from the map interface. In other embodiments, such vehicles may still be displayed as generic vehicle indicators without an associated AID and without being contactable through the V2X communication system.

In the example illustrated in FIG. 1E, the map interface may display the vehicle of User 1 with a corresponding AID (e.g., AID CD1762) and a nearby vehicle of User 2 with a corresponding AID (e.g., AID GZ1412). In the example shown, the AIDs mimic the format of vehicle license plate numbers while remaining anonymized to avoid disclosing personally identifiable information associated with the users. Further, in the example shown, two vehicle indicators are shown (see, e.g., the vehicle icons corresponding to User 3 Vehicle and User 4 Vehicle). These vehicle indicators do not have a corresponding AID. This may be due to the fact that these vehicles are not registered with the V2X communication application or due to the fact that the settings of the corresponding user accounts are configured to prevent communication requests.

In some embodiments, the AIDs may take other forms that facilitate user interaction while preserving privacy. For example, the AIDs may be simplified identifiers such as numeric identifiers (e.g., “Vehicle 1,” “Vehicle 2”), shortened alphanumeric identifiers, or descriptive identifiers associated with vehicle characteristics (e.g., “Blue Toyota,” “White Tesla”). Such identifiers may improve usability by allowing users to more easily recognize and reference nearby vehicles when initiating communication requests.

As shown in FIG. 1F, and by reference number 44, the user may select a vehicle corresponding to a second user account. In some embodiments, the user may select a vehicle by interacting with a graphical vehicle indicator displayed on the map interface. For example, the user may tap, click, or otherwise select the vehicle indicator corresponding to the second vehicle displayed on the map interface. In other embodiments, the user may select the vehicle by providing the AID associated with the second vehicle. For example, the user may input the AID using a keyboard interface, select the AID from a list of nearby vehicles, or provide a voice command that includes the AID (e.g., “Contact vehicle GZ1412”). In some embodiments, the map interface may display a list of nearby vehicles identified by their respective AIDs, allowing the user to select one of the vehicles from the list.

As shown by reference number 46, the user device 12 may provide, to the communication management platform 14, a request to establish a communication session with the selected vehicle. A communication session refers to an interactive exchange of information between two or more users or vehicles facilitated by the communication management platform 14. A communication session may include voice communication, text messaging, multimedia communication, or other forms of data exchange.

In some embodiments, the communication session may be established through a server-mediated relay architecture that preserves anonymity between participants. A server-mediated communication relay refers to an architecture in which communication between devices is routed through the communication management platform 14, rather than occurring through a direct peer-to-peer connection. In some embodiments, the relay may include a Voice-Over Internet Protocol (VoIP) media relay, telephony relay system, or messaging relay service that forwards communications between participants while preventing disclosure of device network endpoints. In some embodiments, the request may include the AID associated with the selected vehicle, an identifier associated with the requesting user account (e.g., a user account identifier or a vehicle session identifier), a request type indicating the desired mode of communication (e.g., voice communication, text messaging, or a combination thereof), a timestamp associated with the request, and/or other metadata used to facilitate routing and authorization of the communication session.

In some embodiments, the request to establish the communication session is ephemeral and auto-expiring. For example, the request may include an expiration time (e.g., 10 seconds, 30 seconds, 2 minutes) after which the request is invalidated and deleted by the communication management platform 14 if not accepted.

As shown by reference number 48, the communication management platform 14 may obtain a routing token for delivering the request to the user device 12-2 associated with the selected second vehicle. As used herein, a routing token refers to a temporary or session-based identifier stored in association with an AID and/or a vehicle session identifier within a data structure (e.g., an AID registry) maintained by the communication management platform 14. The routing token may correspond to an active device connection associated with the user device 12-2. For example, the routing token may identify a communication endpoint maintained by the communication management platform 14 for the user device 12-2, such as a signaling connection, messaging session, or other device communication channel. Using the routing token, the communication management platform 14 may deliver the request to establish the communication session to the user device 12-2 and may initiate or facilitate establishment of the communication session.

To obtain the routing token, the communication management platform 14 may first process the request received from the user device 12-1. The request includes the AID of the selected second vehicle and request metadata, such as a request type (e.g., chat, voice, etc.), a timestamp, one or more session preferences, and/or the like. The communication management platform 14 may then validate the request and the AID. For example, the communication management platform 14 may confirm that the requesting user's account is authenticated and/or authorized to request contact, confirm that the one or more contact conditions are still satisfied for the second user, and/or confirm that the AID associated with the vehicle of the second user is still active. After validating the request, the communication management platform 14 may query an AID registry using the AID of the selected vehicle to obtain the routing token associated with that AID.

In the example shown in FIG. 1F, the AID registry may include an entry in which the AID “GZ1412” is associated with a user account identifier “UAC_993501”, a vehicle session identifier “VS_771902”, and a routing token “RT_5C91B7A4”. The communication management platform 14 may have generated the routing token when the user device 12-2 established an active vehicle session or at a time when the AID was assigned to the vehicle of the second user. In this manner, the routing token allows the communication management platform 14 to deliver communication requests to the appropriate user device without exposing personally identifiable information associated with the user account.

As shown by reference number 50, the communication management platform 14 may use the routing token to provide the request to establish the communication session to the user device 12-2. For example, the communication management platform 14 may use the routing token to identify an active connection associated with the user device 12-2 and may transmit a signaling message to the user device 12-2 over that connection. The signaling message may notify the user device 12-2 that a nearby vehicle associated with a particular AID has requested to establish a communication session. In some embodiments, the signaling message may be transmitted through an application messaging channel, a push notification service, a persistent application socket connection, and/or another signaling interface maintained between the user device 12-2 and the communication management platform 14.

In some embodiments, the routing token is not transmitted to the requesting device and is used internally by the communication management platform 14 to route communication requests and signaling messages to the appropriate user device. In this manner, the communication management platform 14 can facilitate communication between vehicles while preventing disclosure of network endpoint information or other personally identifiable information associated with either user account.

As shown by reference number 52, a second user may interact with the user device 12-2 to respond to the request. In the example shown, the user device 12-2 may be connected to a vehicle system 28-2 associated with the vehicle of the second user. The vehicle system 28-2 may include an infotainment system, a vehicle navigation system, a vehicle communication system, and/or other vehicle components that allow the second user to view the communication request and interact with the user interface using the vehicle display, voice commands, steering wheel controls, or other vehicle input mechanisms. In this case, the user device 12-2 may display a user interface indicating that a nearby vehicle associated with the AID of the requesting vehicle is attempting to establish communication. In some embodiments, the user device 12-2 may also receive and render map overlay data similar to that described in connection with FIG. 1E, enabling the second user to view nearby vehicles and associated AIDs within a map interface. The user interface may include selectable options that allow the second user to accept the request, reject the request, ignore the request, block future requests from the requesting vehicle, and/or perform other communication management actions. In some embodiments, the request notification may be presented within the navigation interface that displays the map overlay, within the V2X communication application interface, and/or as a system-level notification presented by the operating system of the user device 12-2.

As shown in FIG. 1G, and by reference number 54, the communication management platform 14 may establish a communication session between the user device 12-1 and the user device 12-2. In some embodiments, the communication session is a voice communication session implemented using a VoIP framework. In this embodiment, the communication management platform 14 may transmit session configuration information to each user device (e.g., user device 12-1, user device 12-2), including a session identifier, a relay server address, encryption parameters, and/or an audio codec configuration. The session configuration information enables the user devices 12-1, 12-2 to negotiate media parameters and establish encrypted media streams with the relay server. Each user device 12-1, 12-2 may then establish a media connection with a relay server operated by the communication management platform 14 (e.g., rather than directly connecting to the other user device). Audio streams transmitted by the user devices 12-1, 12-2 may be relayed through the relay server so that communication occurs without directly exposing network endpoint information between the user devices 12-1, 12-2. In some embodiments, the VoIP framework may utilize communication technologies such as WebRTC, Session Initiation Protocol (SIP), real-time transport protocol (RTP), and/or other VoIP signaling and media transport technologies.

In the context of VoIP relay systems, network endpoint information refers to address or connection information that enables a device to establish a direct connection with another device over a network. Examples of such information include an IP address, a port number, a device network address, a SIP uniform resource identifier (URI), a WebRTC interactive connectivity establishment (ICE) candidate, network address translation (NAT) traversal information, session traversal utilities for NAT (STUN) endpoints, traversal using relay NAT (TURN) endpoints, and/or other device-specific communication endpoints. By mediating the communication session through the communication management platform 14, the system preserves user anonymity while still enabling real-time communication between nearby vehicles.

When the communication session has been established, the users of respective user devices 12-1, 12-2 are permitted to communicate with each other. In the example dialogue box shown in FIG. 1G, the user states “What's the traffic like up there?” The second user responds, stating “Huge accident, I recommend taking an alternative route.” In other example dialogues, users may discuss driver safety (e.g., “Please slow down, an object is in the road,” “Your brake light is out”), courtesy interactions (e.g., “Thank you for letting me merge”), traffic conditions, or other information relating to a driving scenario or social interaction between drivers. The communication occurs without exposing personal information associated with either user account.

In some embodiments, communication sessions described herein may be initiated by voice command. For example, the user may provide a voice command that includes the AID associated with a nearby vehicle (e.g., “Contact vehicle GZ1412”). Additionally, or alternatively, communication sessions may be initiated by interacting with a graphical user interface, such as selecting a vehicle indicator or AID displayed on the map interface.

In some embodiments, a do-not-disturb (DND) setting is provided. A user may enable the DND setting to temporarily block incoming communication requests from nearby vehicles. When the DND setting is enabled, incoming communication requests may be automatically rejected or suppressed. In some embodiments, the user may configure the DND setting to activate during scheduled time periods, while driving, or for a defined duration.

In some embodiments, the communication management platform 14 may function as an anonymous interchange that establishes communication sessions using routing tokens such that user devices and/or vehicle systems do not receive each other's phone numbers, device identifiers, or direct network addresses. In this manner, communication between users occurs without disclosure of personally identifiable information associated with either user account.

In some embodiments, the communication management platform 14 may implement the communication session using a VoIP relay architecture in which each participant establishes an audio connection with a media relay operated by the communication management platform 14 and the relay forwards or mixes audio streams between participants. In other embodiments, the communication session may be implemented using a relay-calling architecture in which the communication management platform 14 provisions temporary relay numbers associated with the session. Each participant may place a call to a corresponding relay number and the communication management platform 14 may bridge the calls between participants. The relay numbers may be released or deactivated upon termination of the communication session. In some embodiments, the communication management platform 14 may dynamically select between a VoIP relay architecture and a relay-calling architecture based on network conditions, device capabilities, and/or service availability while maintaining anonymity between participants.

In some embodiments, a blocking feature is provided. A user may block specific vehicles, AIDs, and/or vehicle registration identifiers to prevent future communication requests from those vehicles. When a blocked vehicle attempts to initiate communication, the communication management platform 14 may return a generic response such as “user unavailable.” Blocked vehicles may be unblocked through an application settings interface.

In some embodiments, an artificial intelligence (AI) assistant may be implemented to assist users during communication sessions and to reduce driver distraction. The AI assistant may receive audio data associated with the dialogue between users and may process the audio data using machine learning techniques to identify context or recommended actions.

In some embodiments, the AI assistant may receive one or more inputs including audio data and/or transcribed text associated with the communication session, vehicle state data associated with the vehicle system 28 (e.g., vehicle speed, heading, navigation route), and/or contextual map data such as traffic conditions or hazard information obtained from a navigation service. These inputs may be used to identify driving-related context and to infer recommended actions.

The AI assistant may execute on the user device 12, on the communication management platform 14, or as a distributed process between them. The AI assistant may apply one or more machine learning models to generate outputs such as suggested responses, suggested route changes, hazard notifications, or other driving-related recommendations. For example, upon detecting speech indicating an obstruction or accident ahead, the AI assistant may prompt the user with a voice query such as “Would you like to reroute?” If the user accepts the recommendation, the AI assistant may invoke a navigation application programming interface (API) associated with the vehicle system 28 to update the navigation route. In some embodiments, the AI assistant may operate in an ephemeral processing mode in which audio recordings and transcripts associated with the communication session are not permanently stored and are deleted after completion of the session to preserve user privacy.

In this way, the communication management platform 14 enables nearby vehicle operators to establish communication sessions in a manner that preserves privacy, improves situational awareness, and reduces driver distraction. By mediating communication requests using AIDs, routing tokens, and server-mediated communication relays, the communication management platform 14 prevents direct disclosure of personally identifiable information and network endpoint information between participants. Additionally, by maintaining a geospatial presence registry and periodically generating map overlay data representing nearby vehicles, the communication management platform 14 allows users to visualize proximate vehicles and initiate communication using a simple map-based interface integrated with mobile devices and/or vehicle infotainment systems. The communication management platform 14 may further enforce user-defined contact conditions such as visibility preferences, do-not-disturb (DND) settings, and blocking rules, thereby ensuring that communication occurs only under permitted circumstances. As a result, the communication management platform 14 provides a flexible and privacy-preserving V2X communication architecture that enables real-time interaction between nearby vehicles while maintaining user control over visibility, communication preferences, and device information exposure.

The number and arrangement of devices and networks shown in FIGS. 1A-1G are provided as an example. In practice, there may be additional devices and/or networks, fewer devices and/or networks, different devices and/or networks, or differently arranged devices and/or networks than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) of environment 10 may perform one or more functions described as being performed by another set of devices of environment 10.

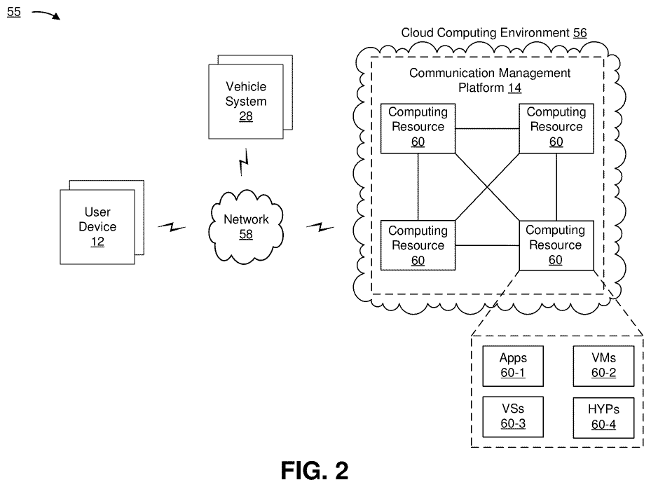

FIG. 2 is a diagram of an example environment 55 in which systems and/or methods described herein may be implemented. As shown in FIG. 2, environment 55 may include one or more user devices 12, one or more vehicle systems 28, a communication management platform 14 supported within a cloud computing environment 56, and/or a network 58.

Devices of environment 55 may communicate using one or more wired or wireless communication networks and/or protocols. For example, a user device 12 may communicate with communication management platform 14 via network 58 using an Internet-based communication protocol such as Hypertext Transfer Protocol (HTTP), Hypertext Transfer Protocol Secure (HTTPS), WebSockets, a real-time messaging protocol, and/or another application-layer communication protocol. In some embodiments, communications between a user device 12, a vehicle system 28, and the communication management platform 14 may be performed using an application programming interface (API) provided by the communication management platform 14. The API may support operations including user registration, identifier resolution, location update publishing, contact request delivery, and anonymous communication session establishment. In some embodiments, a communication session between users may be implemented using a server-mediated Voice-Over Internet Protocol (VoIP) architecture in which each user device 12 establishes a media session with a relay component associated with the communication management platform 14. The relay component bridges audio streams between the participants while preventing exposure of direct network addressing information.

Each user device 12 is configured to receive, generate, store, process, and/or provide information associated with vehicle-to-everything (V2X) communication. For example, a user device 12 (e.g., user device 12-1, user device 12-2, etc.) may include a device, such as a tablet computer (e.g., an iPad, etc.), a mobile phone (e.g., a smart phone, a radiotelephone, etc.), a laptop computer, a handheld computer, a server computer, a gaming device, a wearable communication device (e.g., a smart wristwatch, a pair of smart eyeglasses, etc.), or a similar type of device. In some embodiments, a user device 12 may execute a V2X communication application that communicates with the communication management platform 14 to transmit location updates, receive map overlay data representing nearby vehicles, and initiate communication sessions with other vehicles.

In some embodiments, the user device 12 may communicate with a vehicle system 28 through a display integration interface associated with a vehicle projection framework, a vehicle head unit application, and/or an OEM-specific software development kit (SDK). For example, the V2X communication application executing on the user device 12 may transmit user interface elements, notifications, and/or driver input requests to the vehicle infotainment system of vehicle system 28 through the display integration interface. The vehicle system 28 may render the user interface elements on a vehicle display and may relay driver inputs received from vehicle controls (e.g., touch input, steering wheel controls, or voice commands) back to the user device 12 through the display integration interface. The display integration interface may include, for example, a projection framework interface (e.g., Apple CarPlay®, Android Auto®), a native vehicle head unit application interface, and/or an OEM-specific SDK. This enables presentation of notifications and acceptance/rejection of contact requests while minimizing driver distraction. In some embodiments, incoming contact requests may be presented as notification-style elements and support a voice-based response. In some embodiments, integration relies on system messaging/calling paradigms in which replies and call actions are executed via a voice assistant and/or system calling interface.

Each vehicle system 28 includes one or more devices configured to receive, generate, store, process, and/or provide information associated with V2X communication. For example, a vehicle system 28 (e.g., vehicle system 28-1, vehicle system 28-2, etc.) may include an infotainment system, a navigation system, a communication system, and/or any other vehicle sub-system capable of presenting user interface elements and receiving driver input.

In some embodiments, the vehicle system 28 may provide a display integration interface enabling an application executing on the user device 12 to provide map overlays, receive driver input, and present notifications on a display of the vehicle navigation system. In some embodiments, the vehicle system 28 may include a vehicle integration layer that implements the display integration interface and defines how the user device 12 and the vehicle system 28 exchange user interface events, voice commands, notifications, and display content. The vehicle integration layer may include one or more APIs, a projection framework, a head unit application, and/or other vehicle integration mechanisms.

In some embodiments described herein (see, e.g., FIGS. 1A-1G), communication between vehicles is facilitated using user devices (e.g., user device 12-1 and user device 12-2) that execute the V2X communication application and communicate with the communication management platform 14. In these embodiments, the user devices may perform operations such as transmitting and receiving location data, sending communication requests, receiving signaling messages, and establishing communication sessions with the communication management platform. The respective vehicle systems (e.g., vehicle system 28-1 and vehicle system 28-2), including infotainment systems of the vehicles, may primarily function as user interface devices that present map interfaces, notifications, and communication controls to the drivers.

However, it should be understood that these embodiments are provided by way of example. In practice, the functionality described as being performed by the user devices may instead be implemented directly within vehicle systems, such as within an embedded vehicle infotainment system, vehicle communication module, or other vehicle computing platform. In other embodiments, the system may operate using user devices without integration with a vehicle infotainment system, such that the user device itself provides the user interface and communication functionality. In still other embodiments, processing responsibilities described herein may be distributed differently between user devices 12, vehicle systems 28, and the communication management platform 14 while still enabling the anonymous location-based communication described herein.

Communication management platform 14 includes one or more devices configured to receive, generate, store, process, and/or provide information associated with V2X communication. For example, communication management platform 14 may include a device, such as a server (e.g., a host server, a web server, an application server, etc.), a data center device, or a similar device.

In some embodiments, the communication management platform 14 may provide one or more APIs that support user registration and AID resolution, publish opted-in location updates to maintain a geospatial presence registry, deliver contact requests between proximate vehicles, and/or provision anonymous session routing for a communication session. In some embodiments, provisioning anonymous session routing may include provisioning a VoIP media relay service, a signaling service for establishing media sessions, and/or a telephony relay number that enables participants to communicate without disclosing direct contact information.

In some embodiments, as shown, the communication management platform 14 may be hosted in the cloud computing environment 56. Notably, while embodiments described herein describe the communication management platform 14 as being hosted in the cloud computing environment 56, in some embodiments, the communication management platform 14 may not be cloud-based (i.e., may be implemented outside of a cloud computing environment) or may be partially cloud-based.

Cloud computing environment 56 includes an environment that hosts communication management platform 14. Cloud computing environment 56 may provide computation, software, data access, storage, etc. services that do not require end-user knowledge of a physical location and configuration of system(s) and/or device(s) that hosts the communication management platform 14. As shown, the cloud computing environment 56 may include a group of computing resources 60 (referred to collectively as “computing resources 60” and individually as “computing resource 60”).

Computing resource 60 includes one or more personal computers, workstation computers, server devices, or another type of computation and/or communication device. In some embodiments, the computing resource 60 may host the communication management platform 14. The cloud resources may include compute instances executing in the computing resource 60, storage devices provided in the computing resource 60, data transfer devices provided by the computing resource 60, and/or the like. In some embodiments, the computing resource 60 may communicate with other computing resources 60 via wired connections, wireless connections, or a combination of wired and wireless connections.

As further shown in FIG. 2, computing resource 60 may include a group of cloud resources, such as one or more applications (“APPs”) 60-1, one or more virtual machines (“VMs”) 60-2, virtualized storage (“VSs”) 60-3, one or more hypervisors (“HYPs”) 60-4, and/or the like.

Application 60-1 may include one or more software applications that may be provided to or accessed by user device 12 and/or vehicle system 28. Application 60-1 may eliminate a need to install and execute the software applications on these devices. In some embodiments, one application 60-1 may send/receive information to/from one or more other applications 60-1, via virtual machine 60-2. In some embodiments, application 60-1 may be a V2X communication application. In some embodiments, application 60-1 may include one or more user interfaces that are accessible by users who have registered accounts with the V2X communication application.

Virtual machine 60-2 may include a software implementation of a machine (e.g., a computer) that executes programs like a physical machine. Virtual machine 60-2 may be either a system virtual machine or a process virtual machine, depending upon use and degree of correspondence to any real machine by virtual machine 60-2. A system virtual machine may provide a complete system platform that supports execution of a complete operating system (“OS”). A process virtual machine may execute a single program and may support a single process. In some embodiments, virtual machine 60-2 may execute on behalf of another device (e.g., user device 12) and may manage infrastructure of the cloud computing environment 56, such as data management, synchronization, or long-duration data transfers.

Virtualized storage 60-3 may include one or more storage systems and/or one or more devices that use virtualization techniques within the storage systems or devices of the computing resource 60. In some embodiments, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 60-4 may provide hardware virtualization techniques that allow multiple operating systems (e.g., “guest operating systems”) to execute concurrently on a host computer, such as computing resource 60. Hypervisor 60-4 may present a virtual operating platform to the guest operating systems and may manage the execution of the guest operating systems.

Network 58 includes one or more wired and/or wireless networks. For example, network 58 may include a cellular network (e.g., a fifth generation (5G) network, a fourth generation (4G) network, such as a long-term evolution (LTE) network, a third generation (3G) network, a code division multiple access (CDMA) network, a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, or the like, and/or a combination of these or other types of networks.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 55 may perform one or more functions described as being performed by another set of devices of environment 55.

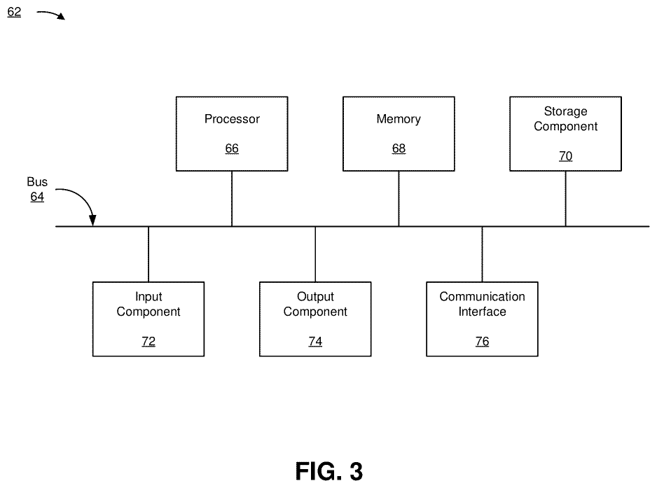

FIG. 3 is a diagram of example components of a device 62. Device 62 may correspond to the one or more user devices 12, the one or more vehicle systems 28, and/or the communication management platform 14. In some embodiments, the user device 12, the one or more vehicle systems 28, and/or the communication management platform 14 may include one or more devices 48 and/or one or more components of device 62. As shown in FIG. 4, device 62 may include a bus 64, a processor 66, a memory 68, a storage component 70, an input component 72, an output component 74, and/or a communication interface 76.

Bus 64 includes a component that permits communication among multiple components of device 62. Processor 66 is implemented in hardware, firmware, and/or a combination of hardware and software. Processor 66 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing component. In some embodiments, processor 66 includes one or more processors capable of being programmed to perform a function. Memory 68 includes a random-access memory (RAM), a read only memory (ROM), and/or another type of dynamic or static storage device (e.g., a flash memory, a magnetic memory, and/or an optical memory) that stores information and/or instructions for use by processor 66.

Storage component 70 stores information and/or software related to the operation and use of device 62. For example, storage component 70 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 72 includes a component that permits device 62 to receive information, such as via user input (e.g., a touch screen display, a keyboard, a keypad, a mouse, a button, a switch, and/or a microphone). Additionally, or alternatively, input component 72 may include a sensor for sensing information (e.g., a global positioning system (GPS) component, an accelerometer, a gyroscope, and/or an actuator). Output component 74 includes a component that provides output information from device 62 (e.g., a display, a speaker, and/or one or more light-emitting diodes (LEDs)).

Communication interface 76 includes a transceiver-like component (e.g., a transceiver and/or a separate receiver and transmitter) that enables device 62 to communicate with other devices, such as via a wired connection, a wireless connection, or a combination of wired and wireless connections. Communication interface 76 may permit device 62 to receive information from another device and/or provide information to another device. For example, communication interface 76 may include an Ethernet interface, an optical interface, a coaxial interface, an infrared interface, a radio frequency (RF) interface, a universal serial bus (USB) interface, a Wi-Fi interface, a cellular network interface, an application programming interface (API), a Bluetooth interface, and/or the like.

Device 62 may perform one or more processes described herein. Device 62 may perform these processes based on processor 66 executing software instructions stored by a non-transitory computer-readable medium, such as memory 68 and/or storage component 70. A computer-readable medium is defined herein as a non-transitory memory device. A memory device includes memory space within a single physical storage device or memory space spread across multiple physical storage devices.

Software instructions may be read into memory 68 and/or storage component 70 from another computer-readable medium or from another device via communication interface 76. When executed, software instructions stored in memory 68 and/or storage component 70 may cause processor 66 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 3 are provided as an example. In practice, device 62 may include additional components, fewer components, different components, or differently arranged components than those shown in FIG. 3. Additionally, or alternatively, a set of components (e.g., one or more components) of device 62 may perform one or more functions described as being performed by another set of components of device 62.

The foregoing disclosure provides illustration and description but is not intended to be exhaustive or to limit the embodiments to the precise form disclosed. Modifications and variations may be made in light of the above disclosure or may be acquired from practice of the embodiments.

The V2X communication application described herein includes certain user interfaces. A user interface may include a graphical user interface, a non-graphical user interface, a text-based user interface, etc. A user interface may provide information for display. In some embodiments, a user may interact with the information, such as by providing input via an input component of a device that provides the user interface for display. In some embodiments, a user interface may be configurable by a device and/or a user (e.g., a user may change the size of the user interface, information provided via the user interface, a position of information provided via the user interface, etc.). Additionally, or alternatively, a user interface may be pre-configured to a standard configuration, a specific configuration based on a type of device on which the user interface is displayed, and/or a set of configurations based on capabilities and/or specifications associated with a device on which the user interface is displayed.

It will be apparent that systems and/or methods, described herein, may be implemented in different forms of hardware, firmware, and/or a combination of hardware and software. The actual specialized control hardware or software code used to implement these systems and/or methods is not limiting of the embodiments. Thus, the operation and behavior of the systems and/or methods were described herein without reference to specific software code-it being understood that software and hardware can be used to implement the systems and/or methods based on the description herein.

No element, act, or instruction used herein should be construed as critical or essential unless explicitly described as such. Also, as used herein, the articles “a” and “an” are intended to include one or more items and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise.

While this invention has been described in conjunction with a number of embodiments, those skilled in the art will recognize that certain modifications to the described embodiments still fall within the spirit and scope of the invention. Accordingly, the scope of this invention is not meant to be limited by the disclosure herein, but may be modified while maintaining its novel process and construction, as would be apparent to one of ordinary skill in the art.

What is claimed is:

1. A method for anonymous, vehicle-to-everything (V2X) communication, comprising:
receiving, by a server and from a device within a first vehicle, location data representing a geographic position of the first vehicle, wherein the device is associated with a first user account of a user registered with a V2X communication application;
identifying, by the server and based on the location data, one or more proximate vehicles located within a predetermined proximity of the geographic position of the first vehicle;
determining, by the server and for each user account corresponding to a respective proximate vehicle of the one or more proximate vehicles, whether the user account is contactable based on one or more contact conditions;
obtaining, by the server, an anonymized identifier (AID) for each proximate vehicle associated with a corresponding user account determined to be contactable;
transmitting, by the server and to the device within the first vehicle, map overlay data including the AID and respective location data for each proximate vehicle associated with the corresponding user account determined to be contactable, wherein transmitting the map overlay data to the device within the first vehicle causes a map interface in the first vehicle to display the map overlay data;
receiving, by the server and from the device within the first vehicle, a request to establish a communication session with a selected second vehicle corresponding to a second user account determined to be contactable, wherein the request includes the AID of the selected second vehicle;
in response to receiving the request, using, by the server, the AID to obtain a routing token and using the routing token to deliver the request to a device within the selected second vehicle without providing personally identifiable information associated with the second user account to the device in the first vehicle; and
establishing, by the server, the communication session between the device within the first vehicle and the device within the selected second vehicle to permit anonymous communication.

2. The method of claim 1, wherein the map overlay data excludes personally identifiable information associated with each proximate vehicle.

3. The method of claim 1, wherein each of the one or more contact conditions represents a condition under which a particular user account is determined to be not contactable, and wherein the one or more contact conditions comprise at least one of:
a do-not-disturb mode enabled for the particular user account,
the particular user account blocking the first user account,
the particular user account not being opted in to location-based visibility within the V2X communication application,
a communication schedule restriction configured for the particular user account, or
a rate limit associated with the particular user account that restricts receipt of additional communication requests.

4. The method of claim 1, wherein the map interface displays the AID for each proximate vehicle associated with the corresponding user account determined to be contactable and a vehicle indicator for each of the one or more proximate vehicles including at least one non-contactable proximate vehicle.

5. The method of claim 1, wherein the device within the first vehicle is a mobile device executing the V2X communication application and is communicatively coupled to a vehicle infotainment system of the first vehicle via a display integration interface, and wherein the map overlay data is rendered as an overlay on the map interface which is presented on a display of the vehicle infotainment system.

6. The method of claim 5, wherein the request to establish the communication session is initiated via a voice command received through the vehicle infotainment system.

7. The method of claim 1, wherein the request to establish the communication session includes the AID as an addressing input used by the server to obtain the routing token for delivering the request without exposing the personally identifiable information associated with the second user account.

8. The method of claim 1, wherein establishing the communication session comprises:
relaying, by the server, an audio communication session between the device within the first vehicle and the device within the selected second vehicle using a server-mediated voice-over-Internet-Protocol (VoIP) relay system such that network endpoint information associated with each device is not directly exposed between the device within the first vehicle and the device within the selected second vehicle.

9. A device, comprising:
one or more memories; and
one or more processors, communicatively coupled to the one or more memories, to:
receive, from a device within a first vehicle, location data representing a geographic position of the first vehicle, wherein the device within the first vehicle is associated with a first user account of a user registered with a vehicle-to-everything (V2X) communication application;
identify, based on the location data, one or more proximate vehicles located within a predetermined proximity of the geographic position of the first vehicle;
determine, for each user account corresponding to a respective proximate vehicle of the one or more proximate vehicles, whether the user account is contactable based on one or more contact conditions;
generate an anonymized identifier (AID) for each proximate vehicle associated with a corresponding user account determined to be contactable;
transmit, to the device within the first vehicle, map overlay data including the AID and respective location data for each proximate vehicle associated with the corresponding user account determined to be contactable, wherein transmitting the map overlay data to the device within the first vehicle causes a map interface in the first vehicle to display the map overlay data;
receive, from the device within the first vehicle, a request to establish a communication session with a selected second vehicle corresponding to a second user account determined to be contactable, wherein the request includes the AID of the selected second vehicle;
in response to receiving the request, use the AID to obtain a routing token and using the routing token to deliver the request to a device within the selected second vehicle without providing personally identifiable information associated with the second user account to the device in the first vehicle; and
establish the communication session between the device within the first vehicle and the device within the selected second vehicle to permit anonymous communication.

10. The device of claim 9, wherein the one or more processors, when generating the AID, are to:
generate the AID as a time-limited identifier that expires after a timer interval, and
wherein the one or more processors are further to:
generate a new AID for the corresponding proximate vehicle upon expiration of the timer interval.

11. The device of claim 9, wherein the map overlay data excludes a vehicle registration identifier for each of the one or more proximate vehicles.

12. The device of claim 9, wherein the one or more processors are further to:
generate the map overlay data to include the AID for each proximate vehicle associated with the corresponding user account determined to be contactable and to further include a vehicle indicator for each of the one or more proximate vehicles including at least one non-contactable proximate vehicle.

13. The device of claim 9, wherein the device within the first vehicle is a user device executing the V2X communication application and is communicatively coupled to a vehicle infotainment system of the first vehicle via a display integration interface, and wherein the map overlay data is rendered as an overlay on the map interface which is presented on a display of the vehicle infotainment system.

14. The device of claim 9, wherein the request to establish the communication session is initiated via a voice command received through the vehicle infotainment system.

15. The device of claim 9. wherein the request to establish the communication session includes the AID as an addressing input used by the one or more processors to obtain the routing token for delivering the request without exposing the personally identifiable information associated with the second user account.

16. The server of claim 9, wherein the one or more processors, when establishing the communication session, are to:
relay an audio communication session between the device within the first vehicle and the device within the selected second vehicle using a server-mediated relay system such that network endpoint information associated with each device is not directly exposed between the device within the first vehicle and the device within the selected second vehicle.

17. A non-transitory, computer-readable medium storing instructions, the instructions comprising:
one or more instructions that, when executed by one or more processors, cause the one or more processors to:
receive, from a device within a first vehicle, location data representing a geographic position of the first vehicle, wherein the device is associated with a first user account of a user registered with a vehicle-to-everything (V2X) communication application;
identify, based on the location data, one or more proximate vehicles located within a predetermined proximity of the geographic position of the first vehicle;
determine, for each user account corresponding to a respective proximate vehicle of the one or more proximate vehicles, whether the user account is contactable based on one or more contact conditions;
generate an anonymized identifier (AID) for each proximate vehicle associated with a corresponding user account determined to be contactable;
transmit, to the device within the first vehicle, map overlay data including the AID and respective location data for each proximate vehicle associated with the corresponding user account determined to be contactable, wherein transmitting the map overlay data to the device within the first vehicle causes a map interface in the first vehicle to display the map overlay data;
receive, from the device within the first vehicle, a request to establish a communication session with a selected second vehicle corresponding to a second user account determined to be contactable, wherein the request includes the AID of the selected second vehicle;
in response to receiving the request, use the AID to obtain a routing token and using the routing token to deliver the request to a device within the selected second vehicle without providing personally identifiable information associated with the second user account to the device in the first vehicle; and
establish the communication session between the device within the first vehicle and the device within the selected second vehicle to permit anonymous communication.

18. The non-transitory computer-readable medium of claim 17, wherein the map overlay data excludes personally identifiable information associated with each proximate vehicle.

19. The non-transitory computer-readable medium of claim 17, wherein the map interface displays the AID for each proximate vehicle associated with the corresponding user account determined to be contactable and a vehicle indicator for each of the one or more proximate vehicles including at least one non-contactable proximate vehicle.

20. The non-transitory computer-readable medium of claim 17, wherein the request to establish the communication session includes the AID as an addressing input used by the server to obtain the routing token for delivering the request without exposing the personally identifiable information associated with the second user account.
